(19) United States
(12) Patent Application Publication
(10) Pub. No.: US 2003/0114349 A1
(43) Pub. Date: Jun. 19, 2003

(54) Coating composition for solid bodies

(75) Inventors: Angelina Pena Romero, Brussels (BE); Steven Rene Martha Ongena, Sint-Gillis Waas (BE)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 10/279,243

(22) Filed: Oct. 24, 2002

Related U.S. Application Data
(63) Continuation of application No. PCT/US01/13453, filed on Apr. 25, 2001.

(30) Foreign Application Priority Data
Apr. 27, 2000 (EP) 00870085.8

(51) Int. Cl. C11D 17/00

(52) U.S. Cl. 510/447; 510/477

(57) ABSTRACT

The present invention relates to coating composition for solid bodies, such as tablets, comprising an ester formed by the esterification or trans-esterification product of a compound having an alcohol or ester function with an acid selected from the group consisting of dicarboxylic acid, polyacid, oligoacid, or mixtures thereof, wherein the weight ratio of the ester to the unreacted acid is less than 1:3. In a second embodiment the coating composition comprises the salt formed by the neutralisation product of an alkali with an acid selected from the group consisting of dicarboxylic acid, oligoacid, polyacid, or mixtures thereof, wherein the weight ratio of the salt to the unreacted acid is less than 1:3.

### CROSS REFERENCE TO RELATED APPLICATIONS

This is a continuation of International Application PCT/US01/13453 with an international filing date of Apr. 25, 2001, published in English under PCT Article 21(2) which claims benefit of European Application No. 00870085.8, filed Apr. 27, 2000.

### TECHNICAL FIELD

The present invention relates to coating compositions for solid bodies, in particular to coating compositions for solid bodies in the form of tablets, capsules, micro-tablets, powders, agglomerates and the like. In particular, it relates to coating compositions for solid bodies having improved dissolution characteristics together with excellent strength, surface hardness and storage stability. The coated solid bodies are suitable for a variety of uses including pharmaceuticals; food and nutrition, such as multi-vitamin tablets, sweeteners; mouthwash; denture cleaning; general cleaners and disinfectants; beauty care, for example bathing additives; agriculture, for example fertilizers; and the like. In the following, however, the invention will be primarily described in terms of detergent tablets.

### BACKGROUND

Compositions in tablet form are well known in the art. Tablets hold several advantages over liquid and particulate composition forms, such as ease of dosing, handling, transportation and storage. Two main issues can still be improved in tablet formulation: dissolution rate and tablet strength. The most usual way to make tablets is by compression of particulate solids usually with a binder. However, a dichotomy exists in that as compression force is increased, the rate of dissolution of the tablets becomes slower. A low compression force, on the other hand, improves dissolution but at the expense of tablet strength. The presence of an external coating can enhance the tablet strength, allowing tabletting at a reduced compaction force which in turn enhances the speed of disintegration of a tablet. While tablets without a coating can be entirely effective in use, they usually lack the necessary surface hardness to withstand the abrasion that is a part of normal manufacture, packaging and handling. The result is that uncoated tablets can suffer from abrasion during these processes, resulting in chipped tablets and loss of active material. Also, especially in the case of highly alkaline compositions, the outer surface of an uncoated tablet may be aggressive to the skin and even somewhat hazardous to handle. In such cases, tablet coating is highly desirable. Finally, coating of tablets is often desired for aesthetic reasons, to improve the outer appearance of the tablet or to achieve some particular aesthetic effect.

Coatings for medicinal agents comprising a mixed ester of a lower fatty acid, a dibasic acid and polyvinyl alcohol are disclosed in JP-B-66 013 996, published on Aug. 31, 1993. PVA having a degree of polymerisation between 200 and 2000 esterified with 40-60 mole % with fatty acid and 60-40 mole % with dibasic acid is disclosed.

Numerous methods of tablet coating have been proposed for detergent tablets. GB-A-983,243 and GB-A-989,638 describe the use of a readily water-soluble organic film forming polymer as a coating material for detergent tablets to make the tablet resistant to abrasion and accidental breakage. The polymeric film is formed by spraying the tablet with an aqueous solution containing between 10 and 25% of polyalcohol and then drying with forced air, heated air or infra-red rays to harden the coating and evaporate the solvent.

GB-A-1,013,686 discloses a detergent tablet surrounded by a coating of an organic water-dispersible binder selected from of vinyl alcohol homopolymers and copolymers.

U.S. Pat. No. 5,916,866 describes tablets with a coating of a film-forming water-soluble organic polymer selected from the group consisting of polyethelene glycol, copolymers of vinyl pyrrolidone and vinyl acetate, and copolymers of maleate and acrylate.

U.S. Pat. No. 4,219,435 discloses a detergent tablet provided with a coating of a hydrated salt having a melting point in the range from 30° C. to 95° C., such coating being applied to the tablet in the form of a melt.

Polymer film-coatings as those described in the prior art usually exhibit good mechanical properties (i.e. strength and elasticity) but they have relatively poor dissolution characteristics in water. Film coatings can tend to slow down the dissolution rate of the tablet by opposing water penetration into the tablet core.

Hydrated salt coatings have a crystalline structure and present a very fast disintegration rate in contact with water. However, they are relatively weak and brittle due to their crystalline nature. Therefore, these coatings do not generally provide good tablet integrity.

As can be seen from the prior art, there is still a need to provide tablets having, at one and the same time, good dissolution rate, surface hardness, strength and integrity. The object of the present invention, therefore, is to provide coated tablets and other solid forms having good mechanical properties as well as having excellent dissolution and disintegration characteristics.

### SUMMARY OF THE INVENTION

In a first embodiment, the present invention provides coating compositions for solid bodies, such as tablets, comprising an ester formed by the esterification or trans-esterification product of a compound having an alcohol or ester function with an acid selected from the group consisting of dicarboxylic acid, polyacid, oligoacid, or mixtures thereof, wherein the weight ratio of the ester to the unreacted acid is less than 1:3. Preferably the weight ratio is between 1:100 and 1:5, preferably between 1:50 and 1:10. Preferred alcohol or ester functional compounds are fully or partly hydrolised polyvinyl alcohol, or polyvinyl acetate, most preferably having a molecular weight between 10 000 and 200 000, preferably between 20 000 and 100 000.

In a second embodiment, the present invention provides coating compositions for solid bodies, such as tablets, comprising the salt formed by the neutralisation product of an alkali with an acid selected from the group consisting of dicarboxylic acid, oligoacid, polyacid, or mixtures thereof, wherein the weight ratio of the salt to the unreacted acid is less than 1:3. Preferably the weight ratio is between 1:100 and 1:5, preferably between 1:50 and 1:10. Preferred alkalis are sodium, potassium, calcium, or magnesium salts of citrate, acetate or hydroxide.

According to the invention, the coating compositions comprise a substantially insoluble dicarboxylic acid and optionally comprises a disintegrant and optionally a component which is liquid at 25° C.

The coating compositions of the present invention comprise dicarboxylic acids. Particularly suitable dicarboxylic acids are selected from the group consisting of oxalic acid, malonic acid, succinic acid, glutaric acid, adipic acid, pimelic acid, suberic acid, azelaic acid, sebacic acid, undecanedioic acid, dodecanedioic acid, tridecanedioic acid and mixtures thereof. Most preferred is adipic acid.

Typically, substantially insoluble materials having a melting point below 40° C. are not sufficiently solid at ambient temperatures and it has been found that materials having a melting point above about 200° C. are less practicable to use. Preferably, an acid having a melting point of more than 90° C. such as azelaic, sebacic acid, dodecanedioic acid is used. An acid having a melting point of more than 145° C. such as adipic acid is particularly suitable.

By “melting point” is meant the temperature at which the material when heated slowly in, for example, a capillary tube becomes a clear liquid.

A coating of any desired thickness can be applied. For most purposes, the coating forms from 1% to 10%, preferably from 1.5% to 5%, of the tablet weight. Tablet coatings are very hard and provide extra strength to the tablet.

In order to promote the dissolution of the coated solid body, a disintegrant can optionally be included in the core and/or the coating. The disintegrant will swell once in contact with water, helping to break the solid body and/or the coating. Suitable disintegrants are described in Handbook of Pharmaceutical Excipients (1986) and include effervescent agents and water-insoluble polymeric disintegrants as well as cation exchange resins and highly soluble components as described below. Examples of suitable disintegrants include starch: natural, modified or pregelatinized starch, sodium starch gluconate; gum: agar gum, guar gum, locust bean gum, karaya gum, pectin gum, tragacanth gum; croscarmylose Sodium, crospovidone, cellulose, algenic acid and its salts including sodium alginate, silicon dioxide, clay, ion exchange resins, polymers containing cationic (e.g. quaternary ammonium) groups, amine-substituted polyacrylates, polymerised cationic amino acids such as poly-L-lysine, polyallylamine hydrochloride) and mixtures thereof. Suitable effervescent agents for use herein include perborate, percarbonate, carbonate and bicarbonate in combination with an inorganic acid such as sulphamic acid or a carboxylic acid such as citric or maleic acid. Preferred herein is a (bi)carbonate/acid effervescent system.

Examples of optional components which are liquid at 25° are including polyethylene glycols, thermal oil, silicon oil, esters of dicarboxylic acids, mono carboxylic acids, paraffin, triacetin, perfumes or alkaline solutions. It is preferred that the structure of the components which is liquid at 25° C. is close to the material forming the crystallised structure, so that the structure is not excessively disrupted. More preferably, the crystallised structure is made of adipic acid, the component which is liquid at 25° C. being available under the name Coasol™ from Chemoxy International, being a blend of the di-isobutyl esters of the glutaric, succinic and adipic acid. The advantage of the use of this component being the good dispersion in the adipic acid to provide flexibility. It should be noted that disintegration of the adipic acid is further improved by the adipate content of Coasol™. Fracture of the coating in the wash can be improved by adding a disintegrant in the coating.

A particularly suitable coating composition, for use herein, comprises an acid having a melting temperature of at least 145° C., such as adipic acid for example, as well as a clay, such as a bentonite clay for example, whereby the clay is used as a disintegrant and also to render the structure of adipic acid more favourable for water penetration, thus improving the dispersion of the adipic acid in a aqueous medium. Preferred are clays having a particle size of less than 75 μm, more preferably of less than 53 μm, in order to obtain the desired effect on the structure of the acid. Preferred are bentonite clays. Indeed the acid has a melting point such that traditional cellulosic disintegrants undergo a thermal degradation during the coating process, whereas such clays are found to be more heat stable. Further, traditional cellulosic disintegrant such as Nymcel™ for example are found to turn brown at these temperatures.

In preferred embodiments of the invention the solid body is in the form of a single or multi-phase detergent tablet, i.e., detergent tablets having a single or multi-phase tablet core. Multi-phases tablets include tablets having multiple layers as well as tablets having a depression or mould in the main body of the tablet and a compressed or non-compressed portion contained within the depression or mould. In such embodiments, the multi-phase tablet can comprises a partial coating which extends across one or more phases of the core so as to provide differential dissolution or release of the active components of the core.

The coating of the solid body is produced according to a process comprising the step of contacting the body with the coating composition. Preferably the coating composition comprises little water, and more preferably the coating composition is essentially anhydrous. Preferred processes include coating baths and shower coatings. The solid body may be provided with a continuous coating or, alternatively, the solid body may be coated with a network of fibres, the meshes of which define the pores of the coating. In the latter case there is provided a coated solid body comprising a core of an active composition and having a porous water-soluble or dispersible fibre network coating (sometimes referred to herein as a “net-coating”). Preferably, the net-coating has an average mesh size in the range from about 5 μm to about 200 μm and preferably from about 10 μm to about 100 μm. Pore size and mesh size are expressed as the square root of the cross-sectional area of the pore or mesh in the plane of the coating.

The objective of the present invention is to provide coated detergent tablets and other solid bodies with excellent dissolution characteristics as well as excellent mechanical properties. This is achieved by coating the solid body. The composition of the invention preferable take the form of a single or multi-phase detergent tablet and can include one or more active and auxiliary components of detergent tablets as described in detail below.

Auxiliary Coating Materials

The compositions herein can include an auxiliary coating, between the solid body and the coating, comprising a crystallised structure. By crystallised, it should be understood that the coating comprises a material which is solid at ambient temperature (25° C.) and has a structure exhibiting some order. This can be detected typically by usual crystallography techniques e.g. X-ray analysis, on the material itself. Preferably, the material forming the crystallised structure does not co-crystallised or only partially with the optional component which is liquid at 25° C. mentioned above. Indeed, it is preferred that the optional component remains in the liquid state at 25° C. in the coating crystalline structure in order to provide flexibility to the structure and resistance to mechanical stress. The optional component which is liquid at 25° C. may advantageously have a functionality in the washing of laundry, for example silicone oil which provides suds suppression benefits or perfume oil.

Highly Soluble Compounds

The compositions herein can further comprise a highly soluble compound. Such a compound could be formed from a mixture or from a single compound. A highly soluble compound is defined as follow:

A solution is prepared as follows comprising de-ionised water as well as 20 grams per litre of a specific compound:

1. 20 g of the specific compound is placed in a Sotax Beaker. This beaker is placed in a constant temperature bath set at 10° C. A stirrer with a marine propeller is placed in the beaker so that the bottom of the stirrer is at 5 mm above the bottom of the Sotax beaker. The mixer is set at a rotation speed of 200 turn per minute.

2. 980 g of the de-ionised water is introduced into the Sotax beaker.

3. 10 s after the water introduction, the conductivity of the solution is measured, using a conductivity meter.

4. Step 3 is repeated after 20, 30, 40, 50, 1 min, 2 min, 5 min and 10 min after step.

5. The measurement taken at 10 min is used as the plateau value or maximum value.

The specific compound is highly soluble according to the invention when the conductivity of the solution reaches 80% of its maximum value in less than 10 seconds, starting from the complete addition of the de-ionised water to the compound. Indeed, when monitoring the conductivity in such a manner, the conductivity reaches a plateau after a certain period of time, this plateau being considered as the maximum value. Such a compound is preferably in the form of a flowable material constituted of solid particles at temperatures comprised between 10 and 80° Celsius for ease of handling, but other forms may be used such as a paste or a liquid. Example of highly soluble compounds include Sodium di isobutylbenzene sulphonate (DIBS) or Sodium toluene sulphonate.

Cohesive Effect

The tablet may comprise a compound having a cohesive effect on the particulate material of a detergent matrix forming the tablet. The cohesive effect on the particulate material of a detergent matrix forming the tablet or a layer of the tablet is characterised by the force required to break a tablet or layer based on the examined detergent matrix pressed under controlled compression conditions. For a given compression force, a high tablet or layer strength indicates that the granules stuck highly together when they were compressed, so that a strong cohesive effect is taking place. Means to assess tablet or layer strength (also refer to diametrical fracture stress) are given in Pharmaceutical dosage forms: tablets volume I Ed. H. A. Lieberman et al, published in 1989.

The cohesive effect is measured by comparing the tablet or layer strength of the original base powder without compound having a cohesive effect with the tablet or layer strength of a powder mix which comprises 97 parts of the original base powder and 3 parts of the compound having a cohesive effect. The compound having a cohesive effect is preferably added to the matrix in a form in which it is substantially free of water (water content below 10% (pref. below 5%)). The temperature of the addition is between 10° and 80° C., more pref. between 10° and 40° C.

A compound is defined as having a cohesive effect on the particulate material according to the invention when at a given compacting force of 3000N, tablets with a weight of 50 g of detergent particulate material and a diameter of 55 mm have their tablet tensile strength increased by over 30% (preferably 60 and more preferably 100%) by means of the presence of 3% of the compound having a cohesive effect in the base particulate material.

An example of a compound having a cohesive effect is Sodium di isoalkylbenzene sulphonate.

When integrating a highly soluble compound having also a cohesive effect on the particulate material used for a tablet or layer formed by compressing a particulate material comprising a surfactant, the dissolution of the tablet or layer in an aqueous solution is significantly increased.

It should be noted that a composition comprising a highly soluble compound as well as a surfactant is disclosed in EP-A-0 524 075, this composition being a liquid composition.

A highly soluble compound having a cohesive effect on the particulate material allows to obtain a tablet having a higher tensile strength at constant compacting force or an equal tensile strength at lower compacting force when compared to traditional tablets. Typically, a whole tablet will have a tensile strength of more than 5 kPa, preferably of more than 10 kPa, more preferably, in particular for use in laundry applications, of more than 15 kPa, even more preferably of more than 30 kPa and most preferably of more than 50 kPa, in particular for use in dish washing or auto dish washing applications; and a tensile strength of less than 300 kPa, preferably of less than 200 kPa, more preferably of less than 100 kPa, even more preferably of less than 80 kPa and most preferably of less than 60 kPa. Indeed, in case of laundry application, the tablets should be less compressed than in case of auto dish washing applications for example, whereby the dissolution is more readily achieved, so that in a laundry application, the tensile strength is preferably of less than 30 kPa.

This allows to produce tablets or layers which have a solidity and mechanical resistance comparable to the solidity or mechanical resistance of traditional tablets while having a less compact tablet or layer thus dissolving more readily. Furthermore, as the compound is highly soluble, the dissolution of the tablet or layer is further facilitated, resulting in a synergy leading to facilitated dissolution for a tablet according to the invention.

Tablet Manufacture

The tablet may comprise several layers. For the purpose of manufacture of a single layer, the layer may be considered as a tablet itself.

Detergent tablets can be prepared simply by mixing the solid ingredients together and compressing the mixture in a conventional tablet press as used, for example, in the pharmaceutical industry. Preferably the principal ingredients, in particular gelling surfactants, are used in particulate form. Any liquid ingredients, for example surfactant or suds suppressor, can be incorporated in a conventional manner into the solid particulate ingredients.

In particular for laundry tablets, the ingredients such as builder and surfactant can be spray-dried in a conventional manner and then compacted at a suitable pressure. Preferably, the tablets according to the invention are compressed using a force of less than 100000N, more preferably of less than 50000N, even more preferably of less than 5000N and most preferably of less than 3000 N. Indeed, the most preferred embodiment is a tablet suitable for laundry compressed using a force of less than 2500N, but tablets for auto dish washing may also be considered for example, whereby such auto dish washing tablets are usually more compressed than laundry tablets.

The particulate material used for making a tablet can be made by any particulation or granulation process. An example of such a process is spray drying (in a co-current or counter current spray drying tower) which typically gives low bulk densities 600 g/l or lower. Particulate materials of higher density can be prepared by granulation and densification in a high shear batch mixer/granulator or by a continuous granulation and densification process (e.g. using Lodige® CB and/or Lodige® KM mixers). Other suitable processes include fluid bed processes, compaction processes (e.g. roll compaction), extrusion, as well as any particulate material made by any chemical process like flocculation, crystallisation sentering, etc. Individual particles can also be any other particle, granule, sphere or grain.

The components of the particulate material may be mixed together by any conventional means. Batch is suitable in, for example, a concrete mixer, Nauta mixer, ribbon mixer or any other. Alternatively the mixing process may be carried out continuously by metering each component by weight on to a moving belt, and blending them in one or more drum(s) or mixer(s). Non-gelling binder can be sprayed on to the mix of some, or all of, the components of the particulate material. Other liquid ingredients may also be sprayed on to the mix of components either separately or premixed. For example perfume and slurries of optical brighteners may be sprayed. A finely divided flow aid (dusting agent such as zeolites, carbonates, silicas) can be added to the particulate material after spraying the binder, preferably towards the end of the process, to make the mix less sticky.

The tablets may be manufactured by using any compacting process, such as tabletting, briquetting, or extrusion, preferably tabletting. Suitable equipment includes a standard single stroke or a rotary press (such as Courtoy®, Korch®, Manesty®, or Bonals®). The tablets prepared according to this invention preferably have a diameter of between 20 mm and 60 mm, preferably of at least 35 and up to 55 mm, and a weight between 25 and 100 g. The ratio of height to diameter (or width) of the tablets is preferably greater than 1:3, more preferably greater than 1:2. The compaction pressure used for preparing these tablets need not exceed 100000 kN/m², preferably not exceed 30000 kN/m², more preferably not exceed 5000 kN/m², even more preferably not exceed 3000 kN/m² and most preferably not exceed 1000 kN/m². Tablets usually have a density of at least 0.9 g/cm³, more preferably of at least 1.0 g/cm³, and preferably of less than 2.0 g/cm³, more preferably of less than 1.5 g/cm³, even more preferably of less than 1.25 g/cm³ and most preferably of less than 1.1 g/cm³.

Multi layered tablets are typically formed in rotating presses by placing the matrices of each layer, one after the other in matrix force feeding flasks. As the process continues, the matrix layers are then pressed together in the pre-compression and compression stages stations to form the multilayer layer tablet. With some rotating presses it is also possible to compress the first feed layer before compressing the whole tablet.

Hydrotrope Compound

A highly soluble compound having a cohesive effect may be integrated to a detergent tablet, whereby this compound is also a hydrotrope compound. Such hydrotrope compound may be generally used to favour surfactant dissolution by avoiding gelling. A specific compound is defined as being hydrotrope as follows (see S. E. Friberg and M. Chiu, J. Dispersion Science and Technology, 9(5 & 6), pages 443 to 457, (1988-1989)):

1. A solution is prepared comprising 25% by weight of the specific compound and 75% by weight of water.

2. Octanoic Acid is thereafter added to the solution in a proportion of 1.6 times the weight of the specific compound in solution, the solution being at a temperature of 20° Celsius. The solution is mixed in a Sotax beaker with a stirrer with a marine propeller, the propeller being situated at about 5 mm above the bottom of the beaker, the mixer being set at a rotation speed of 200 rounds per minute.

3. The specific compound is hydrotrope if the the Octanoic Acid is completely solubilised, i.e . if the solution comprises only one phase, the phase being a liquid phase. The hydrotrope compound is preferably a flowable material made of solid particles at operating conditions between 15 and 60° Celsius.

Hydrotrope compounds include the compounds listed thereafter:

A list of commercial hydrotropes could be found in McCutcheon's Emulsifiers and Detergents published by the McCutcheon division of Manufacturing Confectioners Company. Compounds of interest also include:

1. Nonionic hydrotrope with the following structure:

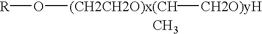

where R is a C8-C10 alkyl chain, x ranges from 1 to 15, y from 3 to 10.

2. Anionic hydrotropes such as alkali metal aryl sulfonates. This includes alkali metal salts of benzoic acid, salicylic acid, bezenesulfonic acid and its many derivatives, naphthoic acid and various hydroaromatic acids. Examples of these are sodium, potassium and ammonium benzene sulfonate salts derived from toluene sulfonic acid, xylene sulfonic acid, cumene sulfonic acid, tetralin sulfonic acid, naphtalene sulfonic acid, methyl-naphtalene sulfonic acid, dimethyl naphtalene sulfonic acid and trimethyl naphtalene sulfonic acid. Other examples include salts of dialkyl benzene sulfonic acid such as salts of di-isopropyl benzene sulfonic acid, ethyl methyl benzene sulfonic acid, alkyl benzene sulfonic acid with an alkyl chain length with 3 to 10, (pref. 4 to 9), linear or branched alkyl sulfonates with an alkyl chain with 1 to 18 carbons.

3. Solvent hydrotropes such as alkoxylated glycerines and alkoxylated glycerides, esters slakoxylated glycerines, alkoxylated fatty acids, esters of glycerin, polyglycerol esters. Preferred alkoxylated glycerines have the following structure:

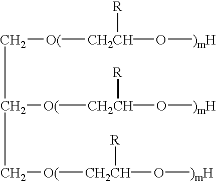

where l, m and n are each a number from 0 to about 20, with l+m+n=from about 2 to about 60, preferably from about 10 to about 45 and R represents H, CH₃ or C₂H₅ Preferred alkoxylated glycerides have the following structure

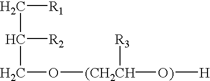

where R1 and R2 are each CₙCOO or —(CH2CHR₃—O)₁—H where R₃=H, CH₃ or C₂H₅ and l is a number from 1 to about 60, n is a number from about 6 to about 24.

4. Polymeric hydrotropes such as those described in EP636687:

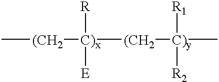

where E is a hydrophilic functional group,

R is H or a C1-C10 alkyl group or is a hydrophilic functional group;

R1 is H a lower alkyl group or an aromatic group,

R2 is H or a cyclic alkyl or aromatic group.

The polymer typically has a molecular weight of between about 1000 and 1000000.

5. Hydrotrope of unusual structure such as 5-carboxy-4-hexyl-2-cyclohexene-1-yl octanoic acid (Diacid®)

Use of such compound in the invention would further increase the dissolution rate of the tablet, as a hydrotrope compound facilitates dissolution of surfactants, for example. Such a compound could be formed from a mixture or from a single compound.

Tensile Strength

For the purpose of measuring tensile strength of a layer, the layer may be considered as a tablet itself.

Depending on the composition of the starting material, and the shape of the tablets, the used compacting force may be adjusted to not affect the tensile strength, and the disintegration time in the washing or dishwashing machine. This process may be used to prepare homogenous or layered tablets of any size or shape.

For a cylindrical tablet, the tensile strength corresponds to the diametrical fracture stress (DFS) which is a way to express the strength of a tablet or layer, and is determined by the following equation:

Tensile strength=2 F/πDt

Where F is the maximum force (Newton) to cause tensile failure (fracture) measured by a VK 200 tablet hardness tester supplied by Van Kell industries, Inc. D is the diameter of the tablet or layer, and t the thickness of the tablet or layer. For a non round tablet, πD may simply be replaced by the perimeter of the tablet. (Method Pharmaceutical Dosage Forms: Tablets Volume 2 Page 213 to 217). A tablet having a diametral fracture stress of less than 20 kPa is considered to be fragile and is likely to result in some broken tablets being delivered to the consumer. A diametral fracture stress of at least 25 kPa is preferred.

This applies similarly to non cylindrical tablets, to define the tensile strength, whereby the cross section normal to the height of the tablet is non round, and whereby the force is applied along a direction perpendicular to the direction of the height of the tablet and normal to the side of the tablet, the side being perpendicular to the non round cross section.

Tablet Dispensing

The rate of dispensing of a detergent tablet can be determined in the following way: Two tablets, nominally 50 grams each, are weighed, and then placed in the dispenser of a Baucknecht® WA9850 washing machine. The water supply to the washing machine is set to a temperature of 20° C. and a hardness of 21 grains per gallon, the dispenser water inlet flow-rate being set to 8 l/min. The level of tablet residues left in the dispenser is checked by switching the washing on and the wash cycle set to wash program 4 (white/colors, short cycle). The dispensing percentage residue is determined as follows:

% dispensing=residue weight×100/original tablet weight

The level of residues is determined by repeating the procedure 10 times and an average residue level is calculated based on the ten individual measurements. In this stressed test a residue of 40% of the starting tablet weight is considered to be acceptable. A residue of less than 30% is preferred, and less than 25% is more preferred.

It should be noted that the measure of water hardness is given in the traditional “grain per gallon” unit, whereby 0.001 mole per litre=7.0 grain per gallon, representing the concentration of Ca²⁺ ions in solution.

Effervescent Agent

Detergent tablets may further comprise an effervescent agent.

Effervescency as defined herein means the evolution of bubbles of gas from a liquid, as the result of a chemical reaction between a soluble acid source and an alkali metal carbonate, to produce carbon dioxide gas,

i.e. C₆H₈O₇+3NaHCO₃→Na₃C₆H₅O₇+3CO₂↑+3H₂O

Further examples of acid and carbonate sources and other effervescent systems may be found in: (Pharmaceutical Dosage Forms: Tablets Volume 1 Page 287 to 291). An effervescent agent may be added to the tablet mix in addition to the detergent ingredients. The addition of this effervescent agent to the detergent tablet improves the disintegration time of the tablet. Preferably the effervescent agent should be added as an agglomerate of the different particles or as a compact, and not as separated particles.

Due to the gas created by the effervescency in the tablet, the tablet can have a higher D.F.S. and still have the same disintegration time as a tablet without effervescency. When the D.F.S. of the tablet with effervescency is kept the same as a tablet without, the disintegration of the tablet with effervescency will be faster.

Further dissolution aid could be provided by using compounds such as sodium acetate or urea. A list of suitable dissolution aid may also be found in Pharmaceutical Dosage Forms: Tablets, Volume 1, Second edition, Edited by H. A. Lieberman et all, ISBN 0-8247-8044-2.

Detersive Surfactants

Surfactant are typically comprised in a detergent composition. The dissolution of surfactants is favoured by the addition of the highly soluble compound.

Nonlimiting examples of surfactants useful herein typically at levels from about 1% to about 55%, by weight, include the conventional C₁₁-C₁₈ alkyl benzene sulfonates (“LAS”) and primary, branched-chain and random C₁₀-C₂₀ alkyl sulfates (“AS”), the C₁₀-C₁₈ secondary (2,3) alkyl sulfates of the formula CH₃(CH₂)ₓ(CHOSO₃₋M⁺) CH₃ and CH₃(CH₂)_{y}(CHOSO₃₋M⁺)CH₂CH₃ where x and (y+1) are integers of at least about 7, preferably at least about 9, and M is a water-solubilizing cation, especially sodium, unsaturated sulfates such as oleyl sulfate, the C₁₀-C₁₈ alkyl alkoxy sulfates (“AE_{X}S”; especially EO 1-7 ethoxy sulfates), C₁₀-C₁₈ alkyl alkoxy carboxylates (especially the EO 1-5 ethoxycarboxylates), the C₁₀-₁₈ glycerol ethers, the C₁₀₋C₁₈ alkyl polyglycosides and their corresponding sulfated polyglycosides, and C₁₂-C₁₈ alpha-sulfonated fatty acid esters. If desired, the conventional nonionic and amphoteric surfactants such as the C₁₂-C₁₈ alkyl ethoxylates (“AE”) including the so-called narrow peaked alkyl ethoxylates and C₆-C₁₂ alkyl phenol alkoxylates (especially ethoxylates and mixed ethoxy/propoxy), C₁₂-C₁₈ betaines and sulfobetaines (“sultaines”), C₁₀-C₁₈ amine oxides, and the like, can also be included in the overall compositions. The C₁₀-C₁₈ N-alkyl polyhydroxy fatty acid amides can also be used. Typical examples include the C₁₂-C₁₈ N-methylglucamides. See WO 9,206,154. Other sugar-derived surfactants include the N-alkoxy polyhydroxy fatty acid amides, such as C₁₀-C₁₈ N-(3-methoxypropyl) glucamide. The N-propyl through N-hexyl C₁₂-C₁₈ glucamides can be used for low sudsing. C₁₀-C₂₀ conventional soaps may also be used. If high sudsing is desired, the branched-chain C₁₀-C₁₆ soaps may be used. Mixtures of anionic and nonionic surfactants are especially useful. Other conventional useful surfactants are listed in standard texts.

Non Gelling Binders

Non gelling binders can be integrated in detergent compositions to further facilitate dissolution.

If non gelling binders are used, suitable non-gelling binders include synthetic organic polymers such as polyethylene glycols, polyvinylpyrrolidones, polyacrylates and water-soluble acrylate copolymers. The handbook of Pharmaceutical Excipients second edition, has the following binders classification: Acacia, Alginic Acid, Carbomer, Carboxymethylcellulose sodium, Dextrin, Ethylcellulose, Gelatin, Guar gum, Hydrogenated vegetable oil type I, Hydroxyethyl cellulose, Hydroxypropyl methylcellulose, Liquid glucose, Magnesium aluminum silicate, Maltodextrin, Methylcellulose, polymethacrylates, povidone, sodium alginate, starch and zein. Most preferable binders also have an active cleaning function in the laundry wash such as cationic polymers, i.e. ethoxylated hexamethylene diamine quaternary compounds, bishexamethylene triamines, or others such as pentaamines, ethoxylated polyethylene amines, maleic acrylic polymers.

Non-gelling binder materials are preferably sprayed on and hence have an appropriate melting point temperature below 90° C., preferably below 70° C. and even more preferably below 50° C. so as not to damage or degrade the other active ingredients in the matrix. Most preferred are non-aqueous liquid binders (i.e. not in aqueous solution) which may be sprayed in molten form. However, they may also be solid binders incorporated into the matrix by dry addition but which have binding properties within the tablet.

It is preferred that gelling binders, such as nonionic surfactants are avoided in their liquid or molten form. Nonionic surfactants and other gelling binders are not excluded from the compositions, but it is preferred that they be processed into the detergent tablets as components of particulate materials, and not as liquids.

Builders

Detergent builders can optionally be included in the compositions herein to assist in controlling mineral hardness. Inorganic as well as organic builders can be used. Builders are typically used in fabric laundering compositions to assist in the removal of particulate soils. The level of builder can vary widely depending upon the end use of the composition. Inorganic or P-containing detergent builders include, but are not limited to, the alkali metal, ammonium and alkanolammonium salts of polyphosphates (exemplified by the tripolyphosphates, pyrophosphates, and glassy polymeric meta-phosphates), phosphonates, phytic acid, silicates, carbonates (including bicarbonates and sesquicarbonates), sulphates, and aluminosilicates. However, non-phosphate builders are required in some locales. Importantly, the compositions herein function surprisingly well even in the presence of the so-called “weak” builders (as compared with phosphates) such as citrate, or in the so-called “underbuilt” situation that may occur with zeolite or layered silicate builders.

Examples of silicate builders are the alkali metal silicates, particularly those having a SiO₂:Na₂O ratio in the range 1.6:1 to 3.2:1 and layered silicates, such as the layered sodium silicates described in U.S. Pat. No. 4,664,839, issued May 12, 1987 to H. P. Rieck. NaSKS-6 is the trademark for a crystalline layered silicate marketed by Hoechst (commonly abbreviated herein as “SKS-6”). Unlike zeolite builders, the Na SKS-6 silicate builder does not contain aluminum. NaSKS-6 has the delta-Na₂SiO₅ morphology form of layered silicate. It can be prepared by methods such as those described in German DE-A-3,417,649 and DE-A-3,742,043. SKS-6 is a highly preferred layered silicate for use herein, but other such layered silicates, such as those having the general formula NaMSixO₂ₓ₊₁.yH₂O wherein M is sodium or hydrogen, x is a number from 1.9 to 4, preferably 2, and y is a number from 0 to 20, preferably 0 can be used herein. Various other layered silicates from Hoechst include NaSKS-5, NaSKS-7 and NaSKS-11, as the alpha, beta and gamma forms. As noted above, the delta-Na₂SiO₅ (NaSKS-6 form) is most preferred for use herein. Other silicates may also be useful such as for example magnesium silicate, which can serve as a crispening agent in granular formulations, as a stabilizing agent for oxygen bleaches, and as a component of suds control systems.

Examples of carbonate builders are the alkaline earth and alkali metal carbonates as disclosed in German Patent Application No. 2,321,001 published on Nov. 15, 1973. Aluminosilicate builders are useful in the present invention. Aluminosilicate builders are of great importance in most currently marketed heavy duty granular detergent compositions, and can also be a significant builder ingredient in liquid detergent formulations. Aluminosilicate builders include those having the empirical formula:

M_{z}(zAlO₂)_{y}].xH₂O

wherein z and y are integers of at least 6, the molar ratio of z to y is in the range from 1.0 to about 0.5, and x is an integer from about 15 to about 264.

Useful aluminosilicate ion exchange materials are commercially available. These aluminosilicates can be crystalline or amorphous in structure and can be naturally-occurring aluminosilicates or synthetically derived. A method for producing aluminosilicate ion exchange materials is disclosed in U.S. Pat. No. 3,985,669, Krummel, et al, issued Oct. 12, 1976.

Preferred synthetic crystalline aluminosilicate ion exchange materials useful herein are available under the designations Zeolite A, Zeolite P (B), Zeolite MAP and Zeolite X. In an especially preferred embodiment, the crystalline aluminosilicate ion exchange material has the formula:

Na₁₂[(AlO₂)₁₂(SiO₂)₁₂)].xH₂O

wherein x is from about 20 to about 30, especially about 27. This material is known as Zeolite A. Dehydrated zeolites (x=0-10) may also be used herein. Preferably, the aluminosilicate has a particle size of about 0.1-10 microns in diameter.

Organic detergent builders suitable for the purposes of the present invention include, but are not restricted to, a wide variety of polycarboxylate compounds. As used herein, “poly-carboxylate” refers to compounds having a plurality of carboxylate groups, preferably at least 3 carboxylates. Polycarboxylate builder can generally be added to the composition in acid form, but can also be added in the form of a neutralized salt. When utilized in salt form, alkali metals, such as sodium, potassium, and lithium, or alkanolammonium salts are preferred.

Included among the polycarboxylate builders are a variety of categories of useful materials. One important category of polycarboxylate builders encompasses the ether polycarboxylates, including oxydisuccinate, as disclosed in Berg, U.S. Pat. No. 3,128,287, issued Apr. 7, 1964, and Lamberti et al, U.S. Pat. No. 3,635,830, issued Jan. 18, 1972. See also “™S/TDS” builders of U.S. Pat. No. 4,663,071, issued to Bush et al, on May 5, 1987. Suitable ether polycarboxylates also include cyclic compounds, particularly alicyclic compounds, such as those described in U.S. Pat. Nos. 3,923,679; 3,835,163; 4,158,635; 4,120,874 and 4,102,903.

Other useful detergency builders include the ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof.

Citrate builders, e.g., citric acid and soluble salts thereof (particularly sodium salt), are polycarboxylate builders of particular importance for heavy duty liquid detergent formulations due to their availability from renewable resources and their biodegradability. Citrates can also be used in granular compositions, especially in combination with zeolite and/or layered silicate builders. Oxydisuccinates are also especially useful in such compositions and combinations.

Also suitable in the detergent compositions of the present invention are the 3,3-dicarboxy-4-oxa-1,6-hexanedioates and the related compounds disclosed in U.S. Pat. No. 4,566,984, Bush, issued Jan. 28, 1986. Useful succinic acid builders include the C₅-C₂₀ alkyl and alkenyl succinic acids and salts thereof. A particularly preferred compound of this type is dodecenylsuccinic acid. Specific examples of succinate builders include: laurylsuccinate, myristylsuccinate, palmitylsuccinate, 2-dodecenylsuccinate (preferred), 2-pentadecenylsuccinate, and the like. Laurylsuccinates are the preferred builders of this group, and are described in European Patent Application 86200690.5/0,200,263, published Nov. 5, 1986. Other suitable polycarboxylates are disclosed in U.S. Pat. No. 4,144,226, Crutchfield et al, issued Mar. 13, 1979 and in U.S. Pat. No. 3,308,067, Diehl, issued Mar. 7, 1967. See also Diehl U.S. Pat. No. 3,723,322.

Fatty acids, e.g., C₁₂-C₁₈ monocarboxylic acids, can also be incorporated into the compositions alone, or in combination with the aforesaid builders, especially citrate and/or the succinate builders, to provide additional builder activity. Such use of fatty acids will generally result in a diminution of sudsing, which should be taken into account by the formulator. In situations where phosphorus-based builders can be used, and especially in the formulation of bars used for hand-laundering operations, the various alkali metal phosphates such as the well-known sodium tripolyphosphates, sodium pyrophosphate and sodium orthophosphate can be used. Phosphonate builders such as ethane-1-hydroxy-1,1-diphosphonate and other known phosphonates (see, for example, U.S. Pat. Nos. 3,159,581; 3,213,030; 3,422,021; 3,400,148 and 3,422,137) can also be used.

Bleach

The detergent compositions herein may optionally contain bleaching agents or bleaching compositions containing a bleaching agent and one or more bleach activators. When present, bleaching agents will typically be at levels of from about 1% to about 30%, more typically from about 5% to about 20%, of the detergent composition, especially for fabric laundering. If present, the amount of bleach activators will typically be from about 0.1 % to about 60%, more typically from about 0.5% to about 40% of the bleaching composition comprising the bleaching agent-plus-bleach activator.

The bleaching agents used herein can be any of the bleaching agents useful for detergent compositions in textile cleaning, hard surface cleaning, or other cleaning purposes that are now known or become known. These include oxygen bleaches as well as other bleaching agents. Perborate bleaches, e.g., sodium perborate (e.g., mono- or tetra-hydrate) can be used herein. Another category of bleaching agent that can be used without restriction encompasses percarboxylic acid bleaching agents and salts thereof. Suitable examples of this class of agents include magnesium monoperoxyphthalate hexahydrate, the magnesium salt of metachloro perbenzoic acid, 4-nonylamino-4-oxoperoxybutyric acid and diperoxydodecanedioic acid. Such bleaching agents are disclosed in U.S. Pat. No. 4,483,781, Hartman, issued Nov. 20, 1984, U.S. patent application Ser. No. 740,446, Burns et al, filed Jun. 3, 1985, European Patent Application 0,133,354, Banks et al, published Feb. 20, 1985, and U.S. Pat. No. 4,412,934, Chung et al, issued Nov. 1, 1983. Highly preferred bleaching agents also include 6-nonylamino-6-oxoperoxycaproic acid as described in U.S. Pat. No. 4,634,551, issued Jan. 6, 1987 to Burns et al.

Peroxygen bleaching agents can also be used. Suitable peroxygen bleaching compounds include sodium carbonate peroxyhydrate and equivalent “percarbonate” bleaches, sodium pyrophosphate peroxyhydrate, urea peroxyhydrate, and sodium peroxide. Persulfate bleach (e.g., OXONE, manufactured commercially by DuPont) can also be used.

A preferred percarbonate bleach comprises dry particles having an average particle size in the range from about 500 micrometers to about 1,000 micrometers, not more than about 10% by weight of said particles being smaller than about 200 micrometers and not more than about 10% by weight of said particles being larger than about 1,250 micrometers. Optionally, the percarbonate can be coated with silicate, borate or water-soluble surfactants. Percarbonate is available from various commercial sources such as FMC, Solvay and Tokai Denka. Mixtures of bleaching agents can also be used.

Peroxygen bleaching agents, the perborates, the percarbonates, etc., are preferably combined with bleach activators, which lead to the in situ production in aqueous solution (i.e., during the washing process) of the peroxy acid corresponding to the bleach activator. Various nonlimiting examples of activators are disclosed in U.S. Pat. No. 4,915,854, issued Apr. 10, 1990 to Mao et al, and U.S. Pat. No. 4,412,934. The nonanoyloxybenzene sulfonate (NOBS) and tetraacetyl ethylene diamine (TAED) activators are typical, and mixtures thereof can also be used. See also U.S. Pat. No. 4,634,551 for other typical bleaches and activators useful herein. Highly preferred amido-derived bleach activators are those of the formula:

R¹N(R⁵)C(O)R²C(O)L or R¹C(O)N(R⁵)R²C(O)L

wherein R¹ is an alkyl group containing from about 6 to about 12 carbon atoms, R² is an alkylene containing from 1 to about 6 carbon atoms, R⁵ is H or alkyl, aryl, or alkaryl containing from about 1 to about 10 carbon atoms, and L is any suitable leaving group. A leaving group is any group that is displaced from the bleach activator as a consequence of the nucleophilic attack on the bleach activator by the perhydrolysis anion. A preferred leaving group is phenyl sulfonate.

Preferred examples of bleach activators of the above formula include (6-octanamidocaproyl)oxybenzenesulfonate, (6-nonanamidocaproyl)oxybenzenesulfonate, (6-decanamidocaproyl)oxybenzenesulfonate, and mixtures thereof as described in U.S. Pat. No. 4,634,551, incorporated herein by reference.

Another class of bleach activators comprises the benzoxazin-type activators disclosed by Hodge et al in U.S. Pat. No. 4,966,723, issued Oct. 30, 1990, incorporated herein by reference. A highly preferred activator of the benzoxazin-type is:

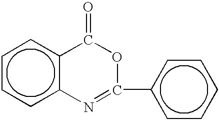

Still another class of preferred bleach activators includes the acyl lactam activators, especially acyl caprolactams and acyl valerolactams of the formula:

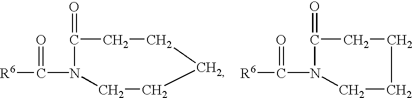

wherein R⁶ is H or an alkyl, aryl, alkoxyaryl, or alkaryl group containing from 1 to about 12 carbon atoms. Highly preferred lactam activators include benzoyl caprolactam, octanoyl caprolactam, 3,5,5-trimethylhexanoyl caprolactam, nonanoyl caprolactam, decanoyl caprolactam, undecenoyl caprolactam, benzoyl valerolactam, octanoyl valerolactam, decanoyl valerolactam, undecenoyl valerolactam, nonanoyl valerolactam, 3,5,5-trimethylhexanoyl valerolactam and mixtures thereof. See also U.S. Pat. No. 4,545,784, issued to Sanderson, Oct. 8, 1985, incorporated herein by reference, which discloses acyl caprolactams, including benzoyl caprolactam, adsorbed into sodium perborate.

Bleaching agents other than oxygen bleaching agents are also known in the art and can be utilized herein. One type of non-oxygen bleaching agent of particular interest includes photoactivated bleaching agents such as the sulfonated zinc and/or aluminum phthalocyanines. See U.S. Pat. No. 4,033,718, issued Jul. 5, 1977 to Holcombe et al. If used, detergent compositions will typically contain from about 0.025% to about 1.25%, by weight, of such bleaches, especially sulfonate zinc phthalocyanine.

If desired, the bleaching compounds can be catalyzed by means of a manganese compound. Such compounds are well known in the art and include, for example, the manganese-based catalysts disclosed in U.S. Pat. No. 5,246,621, U.S. Pat. No. 5,244,594; U.S. Pat. 5,194,416; U.S. Pat. No. 5,114,606; and European Pat. App. Pub. Nos. 549,271A1, 549,272A1, 544,440A2, and 544,490A1; Preferred examples of these catalysts include Mn^{IV}₂(u-O)₃(1,4,7-trimethyl-1,4,7-triazacyclononane)₂(PF₆)₂, Mn^{III}₂(u-O)₁(u-OAc)₂(1,4,7-trimethyl-1,4,7-triazacyclononane)₂-(CIO₄)₂, Mn^{IV}₄(u-O)₆(1,4,7-triazacyclononane)₄(CIO₄)₄, Mn^{III}Mn^{IV}₄(u-O)₁(u-OAc)₂-(1,4,7-trimethyl-1,4,7-triazacyclononane)₂(CIO₄)₃, Mn^{IV}(1,4,7-trimethyl-1,4,7-triazacyclononane)-(OCH₃)₃(PF₆), and mixtures thereof. Other metal-based bleach catalysts include those disclosed in U.S. Pat. No. 4,430,243 and U.S. Pat. No. 5,114,611. The use of manganese with various complex ligands to enhance bleaching is also reported in the following U.S. Pat. Nos. 4,728,455; 5,284,944; 5,246,612; 5,256,779; 5,280,117; 5,274,147; 5,153,161; and 5,227,084.

As a practical matter, and not by way of limitation, the compositions and processes herein can be adjusted to provide on the order of at least one part per ten million of the active bleach catalyst species in the aqueous washing liquor, and will preferably provide from about 0.1 ppm to about 700 ppm, more preferably from about 1 ppm to about 500 ppm, of the catalyst species in the laundry liquor.

Enzymes

Enzymes can be included in the formulations herein for a wide variety of dish or fabric laundering purposes, including removal of protein-based, carbohydrate-based, or triglyceride-based stains, for example, and for the prevention of refugee dye transfer, and for fabric restoration. The enzymes to be incorporated include proteases, amylases, lipases, cellulases, and peroxidases, as well as mixtures thereof. Other types of enzymes may also be included. They may be of any suitable origin, such as vegetable, animal, bacterial, fungal and yeast origin.

However, their choice is governed by several factors such as pH-activity and/or stability optima, thermostability, stability versus active detergents, builders and so on. In this respect bacterial or fungal enzymes are preferred, such as bacterial amylases and proteases, and fungal cellulases.

Enzymes are normally incorporated at levels sufficient to provide up to about 5 mg by weight, more typically about 0.01 mg to about 3 mg, of active enzyme per gram of the composition. Stated otherwise, the compositions herein will typically comprise from about 0.001% to about 5%, preferably 0.01%-1% by weight of a commercial enzyme preparation. Protease enzymes are usually present in such commercial preparations at levels sufficient to provide from 0.005 to 0.1 Anson units (AU) of activity per gram of composition.

Suitable examples of proteases are the subtilisins which are obtained from particular strains of B. subtilis and B. licheniforms. Another suitable protease is obtained from a strain of Bacillus, having maximum activity throughout the pH range of 8-12, developed and sold by Novo Industries A/S under the registered trade name ESPERASE. The preparation of this enzyme and analogous enzymes is described in British Patent Specification No. 1,243,784 of Novo.

Proteolytic enzymes suitable for removing protein-based stains that are commercially available include those sold under the tradenames ALCALASE and SAVINASE by Novo Industries A/S (Denmark) and MAXATASE by International Bio-Synthetics, Inc. (The Netherlands). Other proteases include Protease A (see European Patent Application 130,756, published Jan. 9, 1985) and Protease B (see European Patent Application Serial No. 87303761.8, filed Apr. 28, 1987, and European Patent Application 130,756, Bott et al, published Jan. 9, 1985).

Amylases include, for example, α-amylases described in British Patent Specification No. 1,296,839 (Novo), RAPIDASE, International Bio-Synthetics, Inc. and TERMAMYL, Novo Industries.

The cellulase usable in the present invention include both bacterial or fungal cellulase.

Preferably, they will have a pH optimum of between 5 and 9.5. Suitable cellulases are disclosed in U.S. Pat. No. 4,435,307, Barbesgoard et al, issued Mar. 6, 1984, which discloses fungal cellulase produced from Humicola insolens and Humicola strain DSM1800 or a cellulase 212-producing fungus belonging to the genus Aeromonas, and cellulase extracted from the hepatopancreas of a marine mollusk (Dolabella Auricula Solander). suitable cellulases are also disclosed in GB-A-2.075.028; GB-A-2.095.275 and DE-OS-2.247.832. CAREZYME (Novo) is especially useful.

Suitable lipase enzymes for detergent usage include those produced by microorganisms of the Pseudomonas group, such as Pseudomonas stutzeri ATCC 19.154, as disclosed in British Patent 1,372,034. See also lipases in Japanese Patent Application 53,20487, laid open to public inspection on Feb. 24, 1978. This lipase is available from Amano Pharmaceutical Co. Ltd., Nagoya, Japan, under the trade name Lipase P “Amano,” hereinafter referred to as “Amano-P.” Other commercial lipases include Amano-CES, lipases ex Chromobacter viscosum, e.g. Chromobacter viscosum var. lipolyticum NRRLB 3673, commercially available from Toyo Jozo Co., Tagata, Japan; and further Chromobacter viscosum lipases from U.S. Biochemical Corp., U.S.A. and Disoynth Co., The Netherlands, and lipases ex Pseudomonas gladioli. The LIPOLASE enzyme derived from Humicola lanuginosa and commercially available from Novo (see also EPO 341,947) is a preferred lipase for use herein.

Peroxidase enzymes are used in combination with oxygen sources, e.g., percarbonate, perborate, persulfate, hydrogen peroxide, etc. They are used for “solution bleaching,” i.e. to prevent transfer of dyes or pigments removed from substrates during wash operations to other substrates in the wash solution. Peroxidase enzymes are known in the art, and include, for example, horseradish peroxidase, ligninase, and haloperoxidase such as chloro- and bromo-peroxidase. Peroxidase-containing detergent compositions are disclosed, for example, in PCT International Application WO 89/099813, published Oct. 19, 1989, by O. Kirk, assigned to Novo Industries A/S.

A wide range of enzyme materials and means for their incorporation into synthetic detergent compositions are also disclosed in U.S. Pat. No. 3,553,139, issued Jan. 5, 1971 to McCarty et al. Enzymes are further disclosed in U.S. Pat. No. 4,101,457, Place et al, issued Jul. 18, 1978, and in U.S. Pat. No. 4,507,219, Hughes, issued Mar. 26, 1985, both. Enzyme materials useful for liquid detergent formulations, and their incorporation into such formulations, are disclosed in U.S. Pat. No. 4,261,868, Hora et al, issued Apr. 14, 1981. Enzymes for use in detergents can be stabilized by various techniques. Enzyme stabilization techniques are disclosed and exemplified in U.S. Pat. No. 3,600,319, issued Aug. 17, 1971 to Gedge, et al, and European Patent Application Publication No. 0 199 405, Application No. 86200586.5, published Oct. 29, 1986, Venegas. Enzyme stabilization systems are also described, for example, in U.S. Pat. No. 3,519,570.

Other components which are commonly used in detergent compositions and which may be incorporated into detergent tablets include chelating agents, soil release agents, soil antiredeposition agents, dispersing agents, suds suppressors, fabric softeners, dye transfer inhibition agents and perfumes.

The compounds disclosed above for a product are advantageously packed in a packaging system.

A packaging system may be formed from a sheet of flexible material. Materials suitable for use as a flexible sheet include mono-layer, co-extruded or laminated films. Such films may comprise various components, such as poly-ethylene, poly-propylene, poly-styrene, poly-ethylene-terephtalate. Preferably, the packaging system is composed of a poly-ethylene and bi-oriented-poly-propylene co-extruded film with an MVTR of less than 5 g/day/m². The MVTR of the packaging system is preferably of less than 10 g/day/m², more preferably of less than 5 g/day/m². The film (2) may have various thicknesses. The thickness should typically be between 10 and 150 μm, preferably between 15 and 120 μm, more preferably between 20 and 100 μm, even more preferably between 25 and 80 μm and most preferably between 30 and 40 μm. A packaging material preferably comprises a barrier layer typically found with packaging materials having a low oxygen transmission rate, typically of less than 300 cm³/m²/day, preferably of less than 150 cm³/m²/day, more preferably of less than 100 cm³/m²/day, even more preferably of less than 50 cm³/m²/day and most preferably of less than 10 cm³/m²/day. Typical materials having such barrier properties include bi oriented polypropylene, poly ethylene terephthalate, Nylon, poly(ethylene vinyl alcohol) , or laminated materials comprising one of these, as well as SiOx (Silicium oxydes), or metallic foils such as aluminium foils for example. Such packaging material may have a beneficial influence on the stability of the product during storage for example.

Among the packing method used are typically the wrapping methods disclosed in WO92/20593, including flow wrapping or over wrapping. When using such processes, a longitudinal seal is provided, which may be a fin seal or an overlapping seal, after which a first end of the packaging system is closed with a first end seal, followed by closure of the second end with a second end seal. The packaging system may comprise re-closing means as described in WO92/20593. In particular, using a twist, a cold seal or an adhesive is particularly suited. Indeed, a band of cold seal or a band of adhesive may be applied to the surface of the packaging system at a position adjacent to the second end of the packaging system, so that this band may provide both the initial seal and re-closure of the packaging system. In such a case the adhesive or cold seal band may correspond to a region having a cohesive surface, i.e. a surface which will adhere only to another cohesive surface. Such re-closing means may also comprise spacers which will prevent unwanted adhesion. Such spacers are described in WO 95/13225, published on May 18, 1995. There may also be a plurality of spacers and a plurality of strips of adhesive material. The main requirement is that the communication between the exterior and the interior of the package should be minimal, even after first opening of the packaging system. A cold seal may be used, and in particular a grid of cold seal, whereby the cold seal is adapted so as to facilitate opening of the packaging system.

### EXAMPLES

i) A detergent powder of composition A (see table 1) was prepared as follows: all the particulate materials of composition A were mixed together in a mixing drum to form a homogenous particulate mixture. During the mixing the binder was sprayed on.

TABLE 1
Detergent base powder composition

| | Composition A |
|---|---|
| | (%) |
| Anionic agglomerates 1 | 22.266 |
| Anionic agglomerates 2 | 9.115 |
| Cationic agglomerates | 4.675 |
| Nonionic agglomerates | 6.15 |
| Citric acid | 4.67 |
| Layered silicate, SKS-6 ® | 9.757 |
| Sodium percarbonate | 12.266 |
| Bleach activator agglomerates | 6.093 |
| Sodium carbonate | 10.986 |
| EDDS/Sulphate particle | 0.495 |
| Tetrasodium salt of Hydroxyethane Diphosphonic acid | 0.82 |
| Soil release polymer | 0.363 |
| Fluorescer | 0.23 |
| Soap powder | 1.4 |
| Suds suppressor | 2.8 |
| Polyethylene glycol, Pluriol 4000 ® dry add | 2 |
| Protease | 0.967 |
| Lipase | 0.35 |
| Cellulase | 0.152 |
| Amylase | 1.134 |
| Perfume | 0.561 |
| Binder: | |
| Sodium Di Iso Propyl Benzene Sulphonate | 0.75 |
| Lutensit KHD 96 ® | 0.75 |
| Polyethylene glycol, Pluriol 1000 ® | 0.39 |
| Polyethylene glycol, Pluriol 4000 ® | 0.86 |

Anionic agglomerates 1 comprises 40% AS/AE3S; 27% Zeolite A; 12% sodium carbonate; 9% maleic/acrylic copolymer; the balance being moisture and minor ingredients, impurities etc. Anionic agglomerates 2 comprises 20% AS/AE3S; 20 LAS; 28% Zeolite A; 20% sodium carbonate; the Cationic agglomerates comprises 20% quaternary ammonium compound; 64% Zeolite A; 10% sodium sulphate; the balance being moisture and minor ingredients, impurities etc.

Nonionic agglomerates comprises 24% alkyl ethoxylate (AE7); 11% Zeolite A; 20% sodium carbonate; 36% sodium acetate; the balance being moisture and minor ingredients, impurities etc. Bleach activator agglomerates comprises 81% TAED; 17% acrylic/maleic copolymer and 2% water.

Suds suppressor comprises 11.5% silicone oil; 4.5% hyfac; 13% TAE80 and 71% starch.

Fluorescer comprises 87% Brightener 47 (81% active) and 13% Brightener 49 (100% active).

ii) Core tablets were made using the particulate mixture described in i). The particulate mixture was poured into the hoppers of a Single Punch Rotary Gepa press or Bonals press having round 4.5 cm diameter dies or 42×42 cm square dies and compressed at 1.5 kN or the required force to obtain core tablets with an average tablet weight of about 42.5 g, average tablet hardness of about 2-3 Kp's and average tablet density of about 1030 g/l.

iii) The coating of the core tablets was done as following: the adipic acid is heated in a thermostatic bath at 160-180° C. with gentle stirring until molten. The rest of the ingredients are added slowly, in a continuous step, to the coating bath as powder or as a 10-60% w/w aqueous solution. The round core tablets are dipped into the homogeneous liquid molten coating system and immediately allowed to cool in an aluminum tray and circulating cool air. The square core tablets are coated via dipping and showering with the molten coating system followed by a cooling stage with cool air. Gentle mixing is kept during the whole coating process. The coated tablets will have an average tablet weight of 45 g with an average coating weight of about 2.5 g. Typical coating batch sizes are of 1.0 Kg and 10 Kg.

iv) The tablet hardness of the coated tablets was used to evaluate the resistance towards manufacturing and transport forces. Tablet hardness was measured at least 2 hr after the tablets were coated via a Van Kel-200 tablet hardness tester and reported in Kilo-Points (Kp) as an average of 6-10 individual measurements.

v) The disintegration test is conducted in water at 8° C. and reported as the time in seconds that it takes for the coated tablet to disintegrate. The test is conducted in a 1 L glass beaker containing 600 ml water. The disintegration values are reported as an average of 4-6 individual measurements.

vi) The reference is prepared with core tablets coated only with 96.5% Adipic Acid and 3.5% Sulphonated Polystyrene/Divynylbenzene copolymer (average of about 8% cross-linking level) following the coating procedure described in paragraph iii. The coating compositions containing alcohol, ester or alkali function compounds used to increase the hardness of the coated tablet are shown in Table 2. The tablet hardness results are reported as the hardness increase in % compared to the hardness of the reference [(Kp example−Kp reference)×100/Kp reference]. The disintegration performance is compared to a target disintegration (<30 sec). The results are shown in Table 3.

TABLE 2
Coating Compositions

| Example→ | Ref. | 1 | 2 | 3 | 4 | 5 | 6 | 7 | 8 | 9 | 10 |
|---|---|---|---|---|---|---|---|---|---|---|---|
| Adipic Acid | 96.5 | 95.0 | 93.5 | 96.0 | 96.0 | 86.5 | 95.0 | 95.0 | 95.0 | 95.0 | 95.75 |
| SPS/DVB | 3.5 | 3.5 | 3.5 | 3.5 | 3.5 | 3.5 | 3.5 | 3.5 | 3.5 | 3.5 | 3.5 |
| copolymer | | | | | | | | | | | |
| Opadry ® AMB | — | 1.5 | 3.0 | — | — | — | — | — | — | — | — |
| PVA | — | — | — | 0.5 | — | — | — | — | — | — | — |
| MW ≈ 22,000 | | | | | | | | | | | |
| PVA | — | — | — | — | 0.5 | — | — | — | — | — | — |
| MW ≈ 100,000 | | | | | | | | | | | |
| Erkol ® V03/240 | — | — | — | — | — | 10.0 | — | — | — | — | — |
| Erkopol ® B17 | — | — | — | — | — | — | 1.5 | — | — | — | — |
| Potassium | — | — | — | — | — | — | — | 1.5 | — | — | — |
| Acetate | | | | | | | | | | | |
| Potassium | — | — | — | — | — | — | — | — | 1.5 | — | — |
| Citrate | | | | | | | | | | | |
| Calcium Citrate | — | — | — | — | — | — | — | — | — | 1.5 | — |
| Tetrahydrate | | | | | | | | | | | |
| Sodium | — | — | — | — | — | — | — | — | — | — | 0.75 |
| Hydroxide | | | | | | | | | | | |

SPS/DVB stands for Sulphonated Polystyrene/Divynylbenze copolymer (average of 8% DVB crosslinking level).
Opadry ® AMB is a mixture of Polyvinyl Alcohol, talc, titanium dioxide, xanthan gum and lecithin.
PVA stands for Polyvinyl Alcohol material having molecular weights of about 22,000 (degree of polymerisation = 500 and degree of hydrolisis = 97.5-99.5 mol %) and about 100,000 molecular weight (degree of polymerisation = 2000, degree of hydrolisis = 86-89 mol %).
Erkol ® V03/240 is Polyvinyl Alcohol from Erkol with saponification number = 220-260 mg
KOH/g and degree of hydrolisis = 74.7-79.3 mol %.
Erkopol ® B17 is Polyvinyl Acetate from Erkol with viscosity grade of 2.5-3.5 cps measured as a 10% solution in Ethyl Acetate at 20° C.
The Sodium Hydroxide was added as 50% w/w aqueous solution.

TABLE 3
Tablet hardness and disintegration performance

| Example→ | 1 | 2 | 3 | 4 | 5 | 6 | 7 | 8 | 9 | 10 |
|---|---|---|---|---|---|---|---|---|---|---|
| hardness gain | 28% | 152% | 25% | 15% | 133% | 16% | 23% | 28% | 18% | 38% |
| vs reference | | | | | | | | | | |
| (% increase) | | | | | | | | | | |
| disintegration | Yes | Yes | Yes | Yes | Yes | Yes | Yes | Yes | Yes | Yes |
| (<30 sec) | | | | | | | | | | |

% hardness increase = (Kp example − Kp reference) × 100/Kp reference

What is claimed is:

1. Coating composition for solid bodies, such as tablets, comprising a mixture of an ester and an unreacted acid, the mixture being formed by the the esterification or trans-esterification product of a compound having an alcohol or ester function with an acid selected from the group consisting of dicarboxylic acid, polyacid, oligoacid, or mixtures thereof, wherein the weight ratio of the ester to the unreacted acid is less than about 1:3.

2. Coating composition according to claim 1 wherein the alcohol or ester functional compound is poly vinyl alcohol, poly vinyl acetate, or mixtures thereof.

3. Coating composition according to claim 1 or 2 wherein the alcohol or ester functional compound is a polymer having a molecular weight between about 20 000 and about 80 000.

4. Coating composition according to claim 3 wherein the alcohol functional compound is a hydrolyzed or partly hydrolyzed polyvinyl alcohol.

5. Coating composition according to claim 1 wherein the acid is a dicarboxylic acid which comprises an alkyl chain comprising at least four carbon atoms,

6. Coating composition according to claim 5 wherein the acid is a dicarboxylic acid comprising at least six carbon atoms.

7. Coating composition according to claim 1 wherein the weight ratio of the ester to the unreacted acid is between about 1:100 and about 1:5.

8. Coating composition according to claim 7 wherein the weight ratio of the ester to the unreacted acid is between about 1:50 and about 1:10.

9. Coating composition for solid bodies, such as tablets, comprising a mixture of a salt and an unreacted acid, the mixture being formed by the neutralisation product of an alkali with an acid selected from the group consisting of dicarboxylic acid, oligoacid, polyacid, or mixtures thereof, wherein the weight ratio of the salt to the unreacted acid is less than about 1:3.

10. Coating composition according to claim 8 wherein the alkali is sodium, potassium, calcium, or magnesium salts of citrate, acetate or hydroxide.

11. Coating composition according to claim 9 wherein the dicarboxylic acid comprises an alkyl chain comprising at least four carbon atoms.

12. Coating composition according to claim 11 wherein the dicarboxylic acid comprises an alkyl chain comprising at least six carbon atoms.

13. Coating composition according to claim 9 wherein the weight ratio of the ester to the unreacted acid is between about 1:100 and about 1:5.

14. Coating composition according to claim 13 wherein the weight ratio of the ester to the unreacted acid is between about 1:50 and about 1:10.
